(19) United States
(12) Patent Application Publication
(10) Pub. No.: US 2004/0211035 A1
(43) Pub. Date: Oct. 28, 2004

(54) Door hinge

(76) Inventor: J. Raymond Glover, Medford, OR (US)

Correspondence Address: DELLETT AND WALTERS, P. O. BOX 2786, PORTLAND, OR, 97208-2786, US

(21) Appl. No.: 10/027,819

(22) Filed: Dec. 21, 2001

Related U.S. Application Data
(60) Provisional application No. 60/257,399, filed on Dec. 22, 2000.

(51) Int. Cl. E05D 1/00

(52) U.S. Cl. 16/221

(57) ABSTRACT

A hinge provides an adjustable engagement with a wood frame or door, for example. A wood engaging member has internal threads to receive a bolt therein. The bolt secures a hinge to the wood engaging member. An adjustment member is threadably engaged with the body of the hinge, and receives the bolt therethrough, whereby adjustment of the hinge relative to the door or frame maybe had, while also enabling complete removal of the hinge from the door or frame and re-attachment thereof, while leaving the wood engaging member in place.

### BACKGROUND OF THE INVENTION

This invention relates to hinges, and more particularly to an adjustable hinge for large doors.

Swing open and closed type wood doors typically employ wood screws to mount the hinges to the door. Since multiple screwing and unscrewing of these wood screws leads to degrading of the tightness of the screw's engagement with the door, it is desirable to attach the hinge to the door but once. Similar considerations apply to the door frame or wall portion where the hinge attaches to the fixed portion of the building. These considerations make it important to properly align a door when attaching it. However, as a door becomes larger, it gets heavier, and precise placement and alignment of the door becomes more difficult.

Once the door is in place, adjustment is problematic, if, for example, the door is a bit too high or too low on the edge distal from the hinge, resulting in dragging on the floor or at the door. Removal or loosening of the hinge, for insertion of a shim, for example, to raise or lower the door, again brings up the issue of loosening and re-tightening wood screws in wood, degrading the wood at the screw site.

After installation, heretofore, repair or modifications that required removal of a door would lead to similar issues.

### SUMMARY OF THE INVENTION

In accordance with the invention, a hinge provides an adjustable engagement with a wood frame, for example. A wood engaging member has internal threads to receive a bolt therein. The bolt secures a hinge to the wood engaging member. An adjustment member is threadably engaged with the body of the hinge, and receives the bolt therethrough, whereby adjustment of the hinge relative to the door or frame maybe had, while also enabling complete removal of the hinge from the door or frame and re-attachment thereof, while leaving the wood engaging member in place.

Accordingly, it is an object of the present invention to provide an improved door hinge system.

It is a further object of the present invention to provide an improved adjustment system for a hinge.

It is yet another object of the present invention to provide an improved hinge mounting system that enables removal and reattachment of the hinge to the door or frame, without disturbing the wood of the door or frame.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

FIG. 1 is a perspective view of a door hinge according to the invention;

FIG. 2 is a view of various parts of the hinge, when disassembled;

FIGS. 3A and 3B are top, partially transparent views of the hinge when open and closed, respectively;

FIG. 4 illustrates an adjustment wrench for adjusting the hinge;

FIG. 5 is a perspective view of a typical door as might employ a hinge according to the invention; and

FIG. 6 and FIG. 7 illustrate exemplary dimensions of a particular embodiment.

### DETAILED DESCRIPTION

The system according to a preferred embodiment of the present invention comprises a hinge adapted for adjustment.

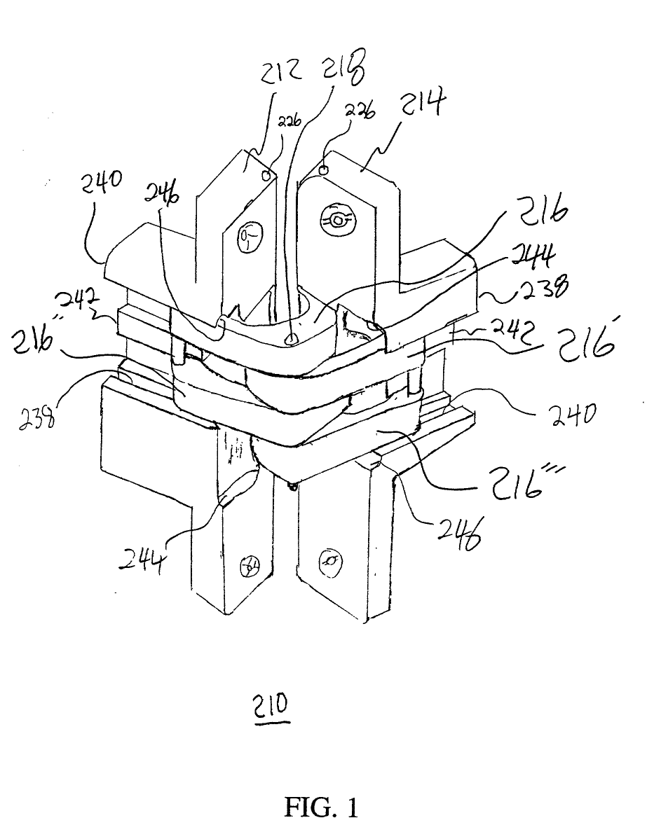

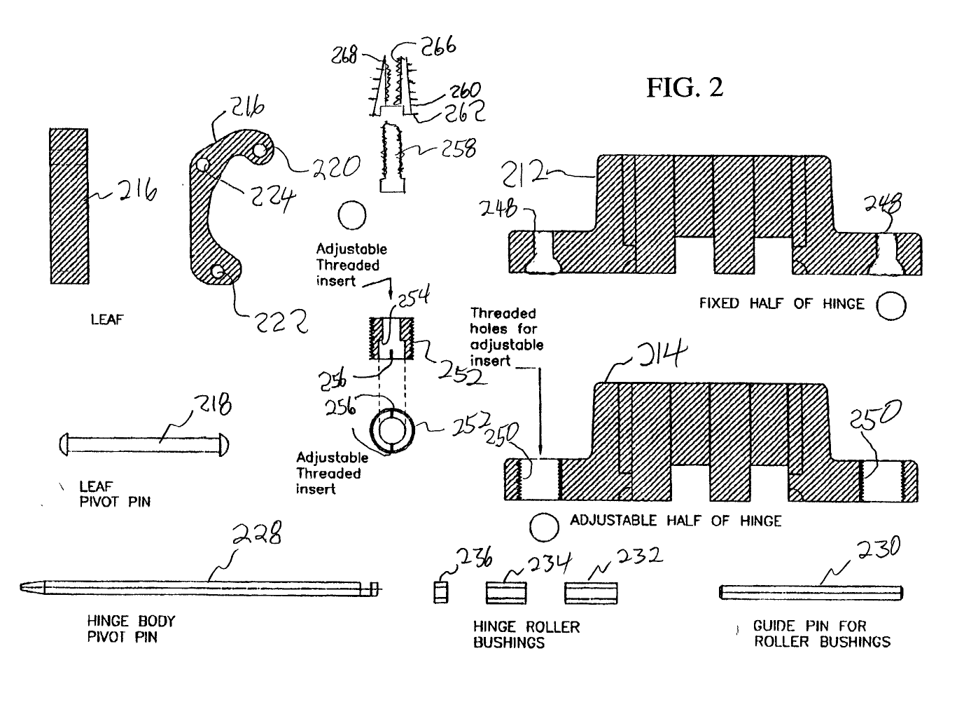

Referring to FIG. 1, a perspective view of a door hinge according to the invention, the hinge 210 comprises a fixed or non-adjusting portion 212 and an adjustable portion 214. Interconnecting the two portions are a set of stacked leaf members 216, there being four such leaf members in the illustrated embodiment. The shape of the leaf members 216 is visible in FIG. 2, which shows the various components of the hinge in disassembled form. The leaf members have three holes bored therethrough, one hole 220, 222, at each of distal ends thereof and a more centrally defined hole 224 approximately one third the length of the leaf in from one end thereof. When the hinge is assembled, the four leaf members 216 are interconnected with a leaf pivot pin 218 that passes through centrally defined holes 224 of each leaf member. The ends of the pivot pin 218 are rolled over to retain the pin in place.

The fixed and adjustable portions of the hinge have pivot pin receiving holes 226 bored vertically therethrough, running substantially the entire length of the hinge portions, and a hinge body pivot pin 228 is received in each of the holes of the two portions. The pivot pins 228 pass through the hole 220 in the respective leaf members 216, the leaf members being arranged so that, with reference to FIG. 1, the top most leaf 216 is pivotally secured to portion 214 through its hole 220, the next lower leaf 216′ is inverted and its hole 220 is secured to portion 212, the next lower leaf 216″ is oriented as is the top most leaf, and its hole 220 is secured to pivot pin 228 of portion 214, and, the bottom most leaf 216′″ is oriented as is leaf 216′, with its hole 220 being secured to portion 212 by its respective pivot pin.

The ends of the leaves 216 opposite the pivot pin 218 receive guide pin 230 therethrough, with hinge roller bushings 232, 234 and 236 positioned thereon. Bushing 236 is the shortest of the three bushings, bushing 234 is somewhat longer, and bushing 232 is the longest of the three, the bushings fitting over the guide pin 230, spaced to ride in corresponding slots 238 (bushing 232) and 240 (bushing 236) defined in hinge portions 212 and 214. Bushing 234 is centrally positioned on the guide pin, and rides on a raised portion 242 defined in the respective portions 212 and 214.

Depressions 244 and 246 are defined in the hinge portions 212 and 214, to provide clearance for the pin 218 when the hinge is closed.

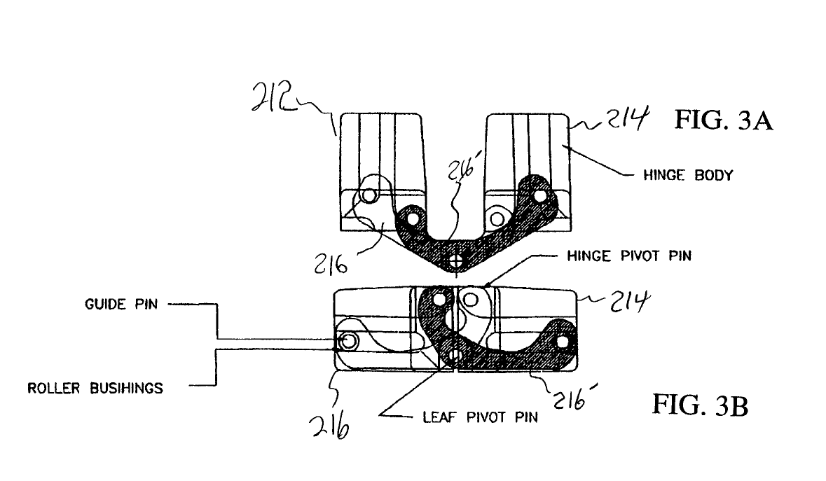

FIGS. 3A and 3B are top, partially transparent views of the hinge when open and closed, respectively.

It may be observed that the hinge portions 212 and 214 are substantially similar to one another, but one of the portions is inverted vertically with respect to the other when assembled. There is a distinction between the two portions. Portion 212 has upper and lower fastener receiving holes bored therethrough, to receive a screw or the like fastener as dictated by the material of which a door or frame are constructed, to secure the portion to either the door, or the corresponding frame.

In contrast, however, portion 214 has threaded holes 250 defined therein, suitably adapted to receive a correspondingly threaded insert 252 therein. The insert 252 has a through bore, which defines a seat 254. A slot 256 is defined on a top face of the insert. A corresponding machine screw 258 is adapted to fit through the threadable insert, the head of the machine screw engaging with the seat 254. A door/frame engaging fastener 260 has a face flange 262 and a hex depression 264 (for engaging with a hex keyed wrench, to turn the fastener). A threaded central through bore 266 is defined through the fastener, with the threads corresponding to the threads of machine screw 258. External threads 268 are defined on the tapered body of the fastener 260.

Thus, in installation of the hinge, the door/frame fastener 260 is secured to the door or frame (which, in the illustrated embodiment would likely be wood). Then, threaded inserts 252 are placed in the two openings 250 of the adjustable hinge portion 214. Now, the machine screw 258 is placed through the opening in the insert, and threaded into the bore of fastener 260, securing the hinge to the door or frame. If adjustment of the hinge relative to the door or the frame is required, it may be accomplished by loosening the machine screw 258, and adjusting the threaded insert 252 inwardly or outwardly, and then re-tightening the machine screw. Thus, the hinge is adjusted, without removal and reinsertion of the portion of the hinge that engages the door or frame, preserving the tight engagement of the threads of fastener 260 to the door or frame. In the case where the door or frame is wood, for example, this is advantageous, as it will not result in repeated insertion and removal of the portion of the hinge attaching directly to the wood, which would lead to degradation of the wood around the fastener, making a less secure engagement between the hinge and the door/frame.

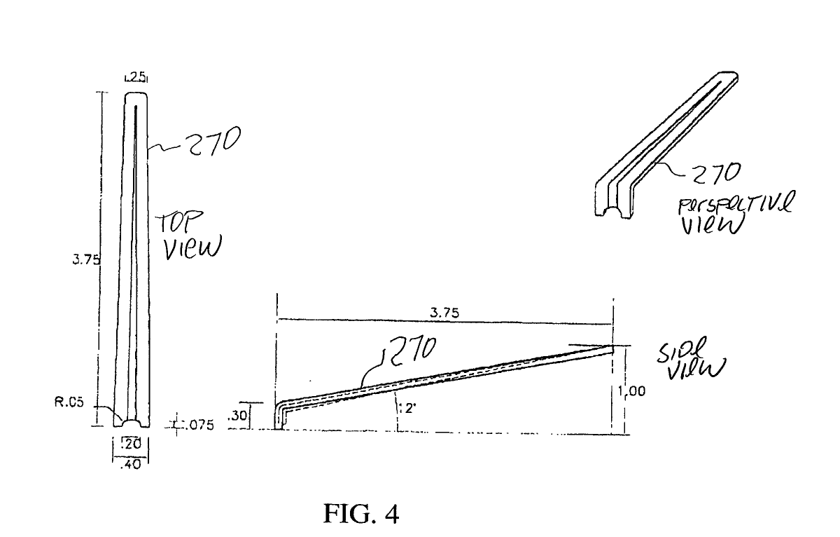

FIG. 4 illustrates an adjustment wrench 270, adapted to engage the slot portions 256 of the adjustable threaded insert 252. Exemplary dimensions are given in inches, for a typical embodiment.

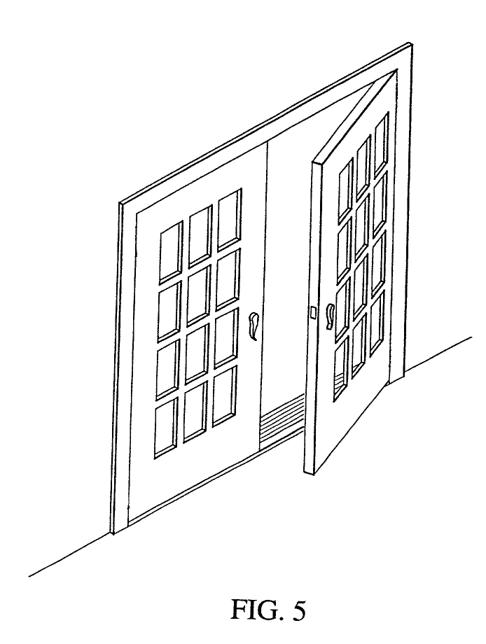

FIG. 5 illustrates a typical door as might employ a hinge according to the invention.

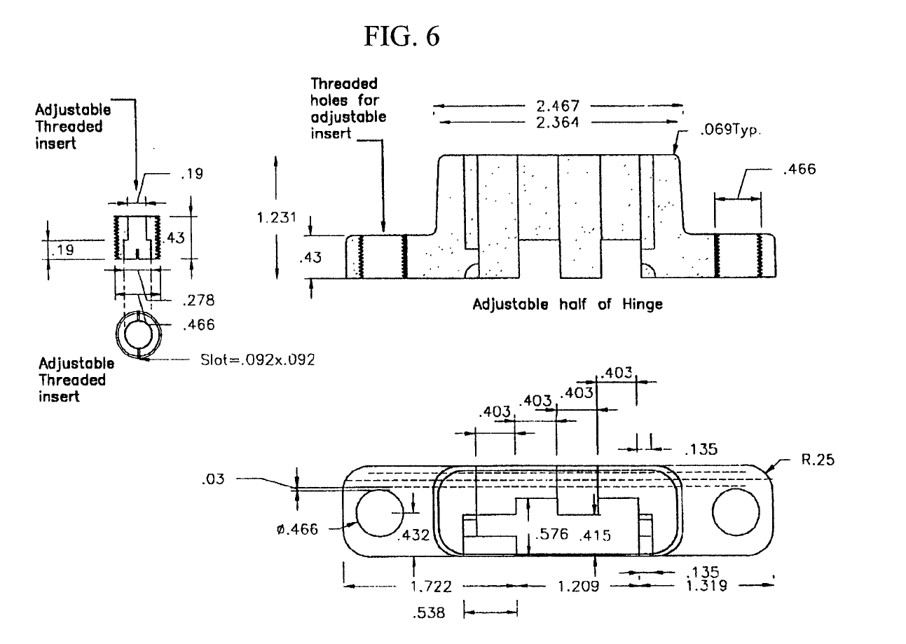

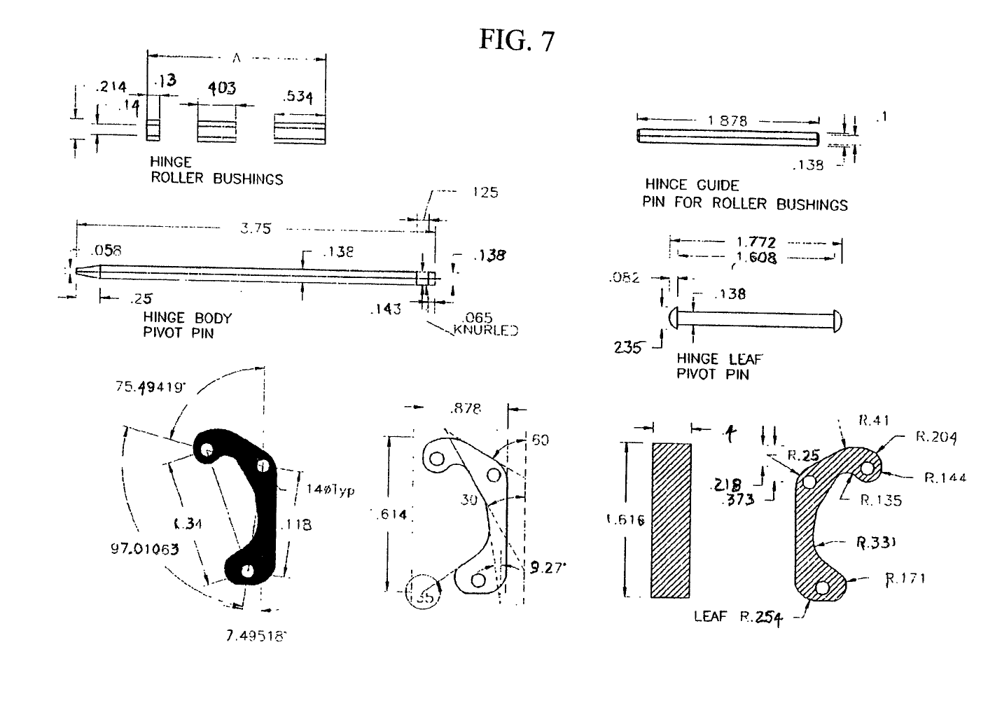

FIG. 6 and FIG. 7 illustrate exemplary dimensions of the various component parts of a door hinge according to the invention.

While a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

1. An adjustable hinge for engagement between a door and a frame, comprising:
a first engaging fastener for securement to the door or frame; and
an adjustable hinge portion adjustably engageable with said first engaging fastener, for enabling adjustment of the hinge portion relative to the door or frame while enabling said first engaging fastener to remain secured to the door or frame.
